(19) United States
(12) Patent Application Publication
(10) Pub. No.: US 2019/0385115 A1
(43) Pub. Date: Dec. 19, 2019

(54) TEMPERATURE-SENSITIVE COLD-CHAIN COMPLIANCE INDICATORS

(71) Applicant: Walmart Apollo, LLC, Bentonville, AR (US)

(72) Inventors: Matthew Biermann, Fayetteville, AR (US); Steven Lewis, Bentonville, AR (US); Suman Pattnaik, Bentonville, AR (US)

(21) Appl. No.: 16/425,774

(22) Filed: May 29, 2019

Related U.S. Application Data
(60) Provisional application No. 62/686,360, filed on Jun. 18, 2018.

(51) Int. Cl. G06Q 10/08; G01K 1/02

(52) U.S. Cl. CPC G06Q 10/087; G06K 7/1417; G01K 1/024

(57) ABSTRACT

Examples provide a system for monitoring cold-chain compliance via temperature-sensitive, cold-chain indicators on perishable item. A cold-chain indicator includes temperature-sensitive ink configured to activate when a temperature outside a per-item threshold temperature range is detected. The color of the ink fades to decrease visibility of a portion of the indicator or the color of the ink darkens to increase visibility of a portion of the indicator. The temperature-sensitive indicator can include a watermark, a barcode, a quick response code, a label, or any other type of indicator. Temperature data is gathered from one or more cold-chain indicators. An analytics component analyzes the temperature data to determine an item's route outside temperature-controlled areas, an amount of time an item has been outside of a temperature-controlled display case, status of a temperature-controlled display case and/or optimal location of temperature-controlled display case storing perishable items.

### BACKGROUND

Perishable items, such as milk and ice cream, frequently require refrigeration or freezing within a predetermined temperature range to prevent spoilage and/or maximize quality of these items. Cold-chain compliance rules can be implemented to assist maintenance of food and other temperature-sensitive items within appropriate temperature range during transport or storage of these perishable items. In some solutions, thermometers are utilized inside storage areas, trailers, and/or refrigerated display cases to manually monitor temperature of perishable items. This manual monitoring is a time-consuming and inefficient process. Moreover, manually monitoring and recording temperature conditions associated with temperature-sensitive items during transport and storage is expensive and labor-intensive.

### SUMMARY

Some examples provide a system for monitoring cold-chain compliance via temperature-sensitive indicators. A set of cold-chain indicators are associated with a set of perishable items within an item selection area. A cold-chain indicator includes temperature-sensitive ink on a portion of the exterior surface of the cold-chain indicator. The temperature-sensitive ink activates to alter the appearance of part of the cold-chain indicator in response to a change in the temperature of an item that is outside a per-item threshold temperature range. A set of one or more sensor devices generates sensor data for the set of cold-chain indicators on each item in the set of perishable items. A compliance component analyzes the sensor data to identify an activated cold-chain indicator on a selected item. The activated cold-chain indicator verifies the occurrence of the temperature change outside the per-item threshold temperature range for the selected item. A user interface device outputs an identification of one or more items associated with an activated cold-chain indicator. A data storage device stores item data associated with the set of perishable items. The item data includes a location of an assigned temperature-controlled display area associated with each item in the set of perishable items, an internal temperature of the assigned temperature-controlled display area associated with each item in the set of perishable items, and/or a planogram associated with the item selection area. A route generator component analyzes the sensor data, the item data, a current temperature of the item and a predetermined warming rate to generate a set of potential routes through the item selection area from the assigned temperature-controlled display areas associated with the set of perishable items and a checkpoint location.

Other examples provide a computer-implemented method for monitoring cold-chain compliance via temperature-sensitive indicators. A compliance component analyzes sensor data generated by one or more sensor devices associated with a cold-chain indicator on an item within an item selection area. The cold-chain indicator includes temperature-sensitive material associated with a portion of an exterior surface of the cold-chain indicator. A notification component generates an alert notification if a result of the analysis indicates the temperature-sensitive material is activated. The activated cold-chain indicator includes an altered appearance of at least a portion of the exterior surface of the cold-chain indicator due to detection of a temperature of the selected item outside a per-item threshold temperature range.

Still other examples provide a cold-chain indicator for monitoring cold-chain compliance. The cold-chain indicator includes one or more temperature-sensitive ink marks on a portion of an exterior surface of the cold-chain indicator. The one or more temperature-sensitive ink marks are configured to activate if a temperature of an item associated with the cold-chain indicator falls outside a per-item threshold temperature range. When activated, a color of the temperature-sensitive ink fades to decrease visibility of the temperature-sensitive ink or the color of the temperature-sensitive ink darkens to increase visibility of the temperature-sensitive ink. The one or more temperature-sensitive ink marks include a first portion of the temperature-sensitive ink configured to activate on condition the temperature falls outside a first temperature range. The set of temperature-sensitive ink marks further include a second portion of the temperature-sensitive ink configured to activate on condition the temperature falls outside a second temperature range.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for managing cold-chain compliance of perishable items.

FIG. 2 is an exemplary block diagram illustrating a system for managing temperature-controlled display areas for cold-chain compliance of items.

FIG. 3 is an exemplary block diagram illustrating an item selection area.

FIG. 4 is an exemplary block diagram illustrating a cold-chain indicator integrated within an item package.

FIG. 5 is an exemplary block diagram illustrating a cold-chain indicator attached to an item.

FIG. 6 is an exemplary block diagram illustrating a cold-chain indicator including a set of temperature-sensitive marks.

FIG. 7 is an exemplary block diagram illustrating activation of a cold-chain indicator.

FIG. 8 is an exemplary block diagram illustrating a cold-chain indicator including at least a portion of a barcode.

FIG. 9 is an exemplary block diagram illustrating a cold-chain indicator including temperature indicators.

FIG. 10 is an exemplary block diagram illustrating a cold-chain manager component.

FIG. 11 is an exemplary block diagram illustrating a database storing cold-chain compliance data.

FIG. 12 is an exemplary block diagram illustrating a set of potential routes through an item selection area.

FIG. 13 is an exemplary flow chart illustrating operation of the computing device to determine whether a cold-chain indicator is activated based on an analysis of sensor data associated with a cold-chain indicator.

FIG. 14 is an exemplary flow chart illustrating operation of the computing device to manage temperature-controlled item display areas based on cold-chain indicator data.

FIG. 15 is an exemplary flow chart illustrating operation of the computing device to relocate perishable items based on cold-chain indicator data.

Corresponding reference characters indicate corresponding parts throughout the drawings.

### DETAILED DESCRIPTION

Referring to the figures, examples of the disclosure provide irreversible cold-chain indicators including temperature-sensitive ink for monitoring temperature of items. Temperature-sensitive ink can also be referred to as thermo-chromatics. In some examples, the temperature-sensitive ink activates to irreversibly alter an appearance of a portion of the cold-chain indicator if the temperature of an item falls outside an acceptable temperature range. The portion of the cold-chain indicator can include only some or part of the cold-chain indicator, as well as the entire cold-chain indicator. In other words, a portion of the cold-chain indicator can fade or become darker when activated while another portion of the indicator remains unchanged. In other examples, when the cold-chain indicator activates, the entire indicator alters appearance.

Cold-chain indicator activation alters appearance of the indicator to enable a user or automated system to instantly determine whether an item has remained cold-chain compliant since attachment of the indicator to the item via a visual inspection or scan of the indicator. Activation of the mark indicates that the item was too warm or too cold at some point after the indicator was attached to the item or incorporated into item packaging. This enables quick and efficient determination of cold-chain compliance, as well as automatic recording of previous temperatures experienced by an item or indicator without human intervention.

Other examples provide a cold-chain manager component that analyzes cold-chain indicator data from a plurality of instances of items stored in the same temperature-controlled area to monitor/maintain the temperature-controlled display area. If one or more cold-chain indicators on items stored in the display area activate, the activation can indicate the temperature-controlled display area requires maintenance, repair, thermostat adjustment or relocation. This enables improved maintenance, optimization of location and temperature settings, as well as improved timeliness for identifying mechanical problems associated with refrigerators and/or freezer displays.

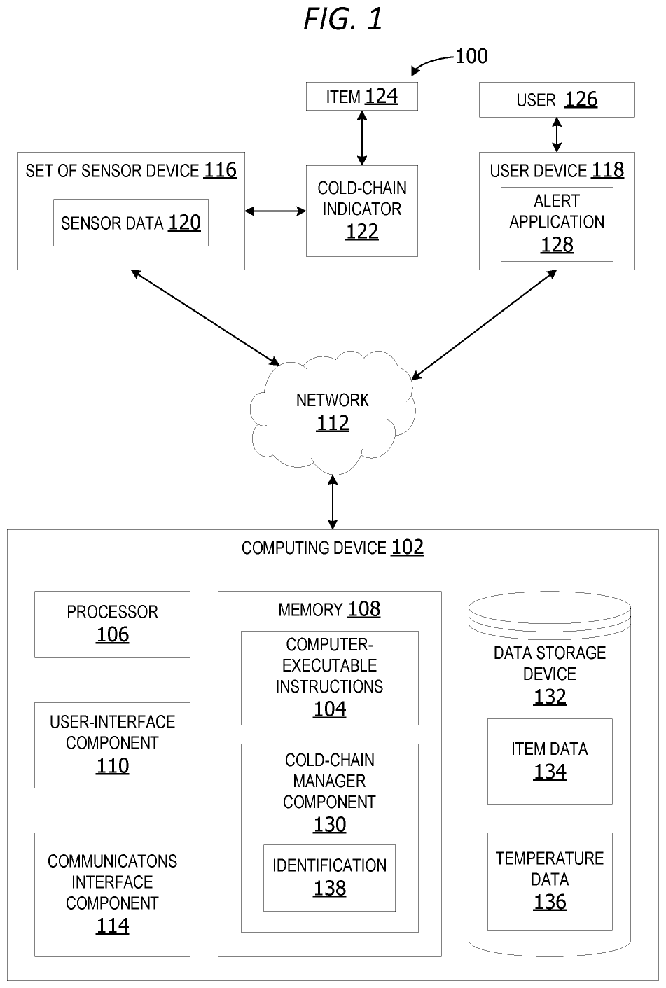

Referring again to FIG. 1, an exemplary block diagram illustrates a system 100 for managing cold-chain compliance of perishable items. In the example of FIG. 1, the computing device 102 represents any device executing computer-executable instructions 104 (e.g., as application programs, operating system functionality, or both) to implement the operations and functionality associated with the computing device 102. The computing device 102 can include a mobile computing device or any other portable device. In some examples, the mobile computing device includes a mobile telephone, laptop, tablet, computing pad, netbook, gaming device, and/or portable media player. The computing device 102 can also include less-portable devices such as servers, desktop personal computers, kiosks, or tabletop devices. Additionally, the computing device 102 can represent a group of processing units or other computing devices.

In some examples, the computing device 102 has at least one processor 106 and a memory 108. The computing device 102 can also include a user interface device 110.

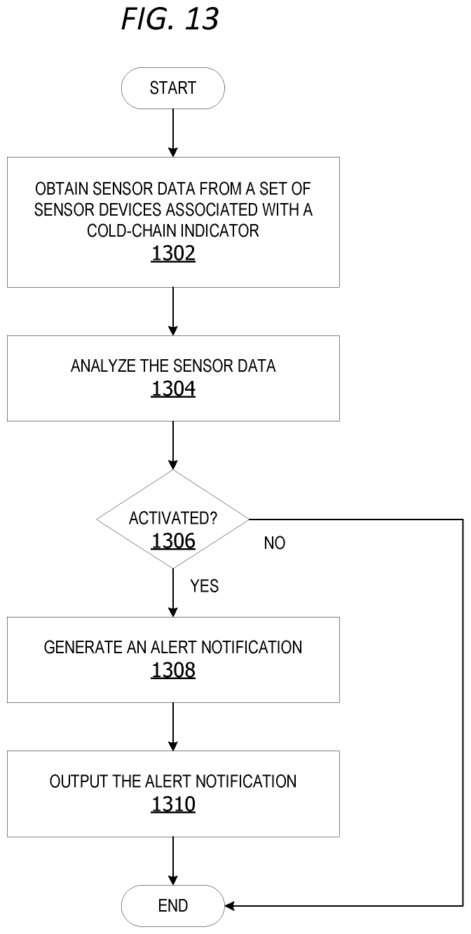

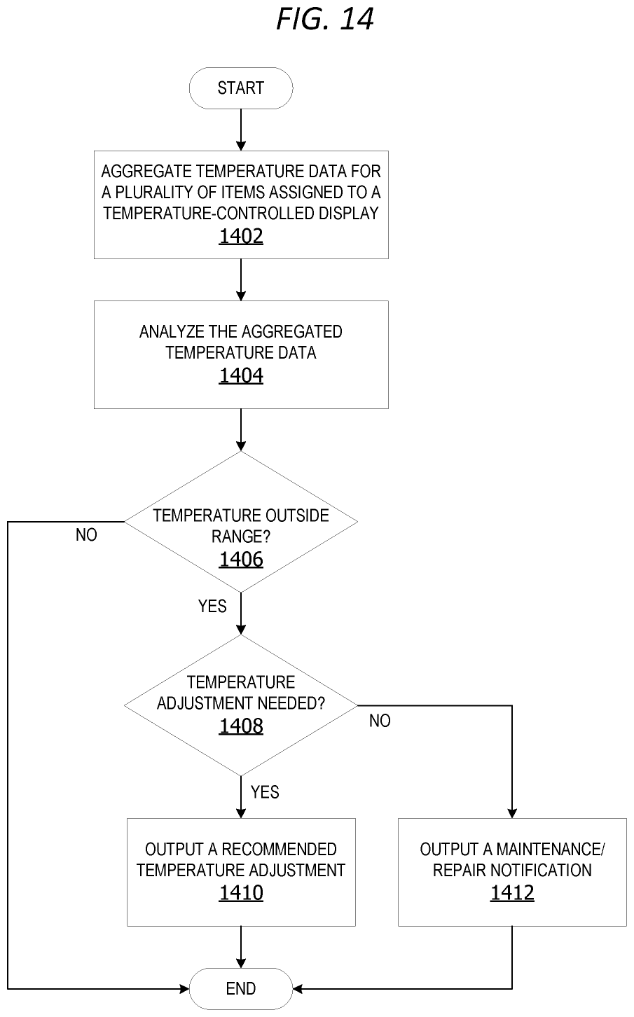

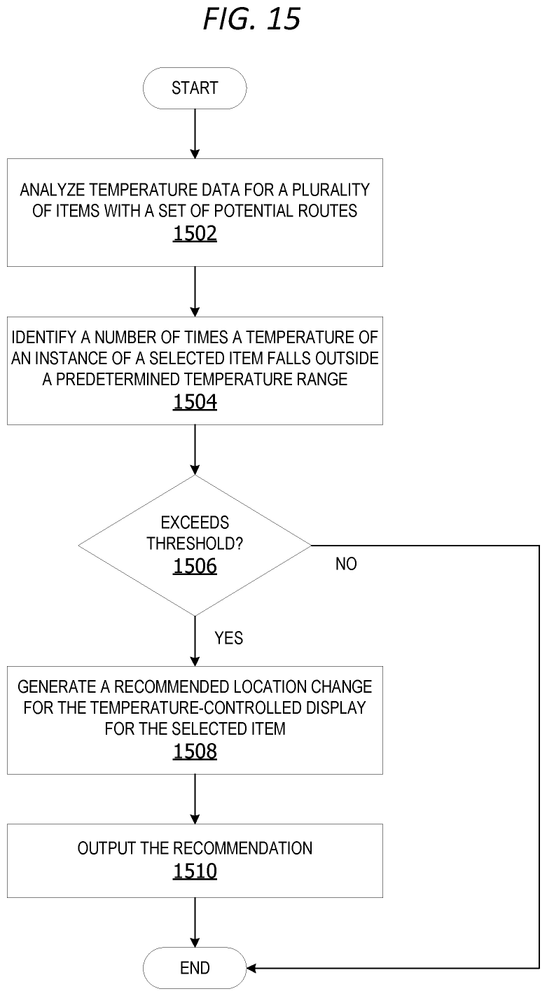

The processor 106 includes any quantity of processing units, and is programmed to execute the computer-executable instructions 104. The computer-executable instructions 104 can be performed by the processor 106 or by multiple processors within the computing device 102 or performed by a processor external to the computing device 102. In some examples, the processor 106 is programmed to execute instructions such as those illustrated in the figures (e.g., FIG. 13, FIG. 14 and FIG. 15).

The computing device 102 further has one or more computer-readable media such as the memory 108. The memory 108 includes any quantity of media associated with or accessible by the computing device 102. The memory 108 can be internal to the computing device 102 (as shown in FIG. 1), external to the computing device (not shown), or both (not shown). In some examples, the memory 108 includes read-only memory and/or memory wired into an analog computing device.

The memory 108 stores data, such as one or more applications. The applications, when executed by the processor 106, operate to perform functionality on the computing device 102. The applications can communicate with counterpart applications or services, such as, but not limited to, web services accessible via a network 112. For example, the applications can represent downloaded client-side applications that correspond to server-side services executing in a cloud.

In other examples, the user interface device 110 includes a graphics card for displaying data to the user and receiving data from the user. The user interface device 110 can also include computer-executable instructions (e.g., a driver) for operating the graphics card. Further, the user interface device 110 can include a display (e.g., a touch screen display or natural user interface) and/or computer-executable instructions (e.g., a driver) for operating the display. The user interface device 110 can also include one or more of the following to provide data to the user or receive data from the user: speakers, a sound card, a camera, a microphone, a vibration motor, one or more accelerometers, a BLUETOOTH® brand communication module, global positioning system (GPS) hardware, and a photoreceptive light sensor. For example, the user can input commands or manipulate data by moving the computing device 102 in one or more ways.

The network 112 is implemented by one or more physical network components, such as, but without limitation, routers, switches, network interface cards (NICs), and other network devices. The network 112 can be any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other examples, the network 112 is a local or private LAN.

In some examples, the system 100 optionally includes a communications interface component 114. The communications interface component 114 includes a network interface card and/or computer-executable instructions (e.g., a driver) for operating the network interface card. Communication between the computing device 102 and other devices, such as but not limited to a set of sensor devices 116 or a user device 118, can occur using any protocol or mechanism over any wired or wireless connection. In some examples, the communications interface component 114 is operable with short range communication technologies such as by using near-field communication (NFC) tags.

The set of sensor devices 116 includes one or more sensor devices generating sensor data 120 associated with at least one cold-chain indicator 122 on at least one item in an item selection area, such as the item 124. The item selection area is an area including one or more items, such as a warehouse, a distribution center, a truck loading/unloading area, a store and/or a department within a store. A department includes any area, center, or section within a store. A store can include, for example, but without limitation, a grocery store, a hardware store, an auto-parts store, a garden center, an office supplies center, a clothing department, or any other type of store or department within a store.

The user device 118 represents any device executing computer-executable instructions associated with a user 126. The user device 118 can be implemented as a mobile computing device, such as, but not limited to, a wearable computing device, a mobile telephone, laptop, tablet, computing pad, netbook, gaming device, and/or any other portable device. The user device 118 includes at least one processor and a memory. The user device 118 can also include a user interface component. In some examples, the user device 118 executes an alert application 128 for receiving notification alerts from a cold-chain manager component 130 executing on the computing device 102.

The system 100 can optionally include a data storage device 132 for storing data, such as, but not limited to item data 134 associated with perishable items, such as the item 124. The data storage device 132 can also include temperature data 136 obtained from cold-chain indicators, such as the cold-chain indicator 122 in FIG. 1.

Temperature data 136 is data associated with the temperature of one or more items, one or more temperature-controlled areas, and/or one or more cold-chain indicators. A temperature-controlled area can include a freezer display case, a refrigerated display case, a refrigerated truck, or refrigerated storage room, or any other area in which temperature is maintained at a higher or lower temperature than the ambient temperature within the item selection area.

The data storage device 132 can include one or more different types of data storage devices, such as, for example, one or more rotating disks drives, one or more solid state drives (SSDs), and/or any other type of data storage device. The data storage device 132 in some non-limiting examples includes a redundant array of independent disks (RAID) array. In other examples, the data storage device 132 includes a database.

The data storage device 132 in this example is included within the computing device 102 or associated with the computing device 102. In other examples, the data storage device 132 can be a remote data storage accessed by the computing device via the network 112, such as a remote data storage device, a data storage in a remote data center, or a cloud storage.

The memory 108 in some examples stores one or more computer-executable components. Exemplary components include the cold-chain manager component 130. The cold-chain manager component 130 in some examples analyzes the sensor data 120 with the item data 134 and/or the temperature data 136 to identify items having an activated cold-chain indicator. In other words, the cold-chain manager component 130 automatically analyzes sensor data 120 to determine if a cold-chain indicator is activated and/or determine if the item 124 is cold-chain compliant or non-compliant based on temperature data obtained from the cold-chain indicator 122.

For example, if the activated cold-chain indicator has an altered appearance which indicates the temperature of the item was too high at some previous time, the system outputs a message indicating the item should be replaced, returned or discarded. In another example, even if the indicator verifies cold-chain compliance for the item (temperature of item always within acceptable temperature range), the system can obtain temperature data from the indicator which is analyzed for temperature fluctuations or variations during transport and/or storage for improved management of perishable items, maximizing food freshness and ensuring cold-chain compliance.

This further enables the system to automatically flag non-compliant items as well as verify items are cold-chain compliant prior to sale or consumption for improved safety and quality of perishable items. In some examples, the system sends a notification alert, including an identification 138 of the item 124, indicating the item 124 is non-compliant and should be replaced due to temperature of the item falling outside an acceptable temperature threshold range or compliant for cold-chain verification of individual items, cases of items and/or pallets of items.

The cold-chain indicator 122 in some non-limiting examples is a binary barcode watermark which fades to the point of not being able to be read by a barcode reader upon activation of the indicator. The barcode fades away becoming completely invisible. The barcode can include a universal product code (UPC), a matrix barcode or any other type of barcode.

In other examples, the cold-chain indicator 122 is a barcode that changes by adding a one or more bars to the barcode to change the barcode slightly upon activation of the indicator. The altered barcode prompts an error at checkout. The error indicates the item being scanned should be replaced or substituted with a different item. If the barcode is changed dramatically, the cashier can just enter the code manually, which would prevent the error being generated at checkout. The cold-chain indicator, in other examples, manifests a line or slash through the barcode numbers to prevent manual override when activated by a temperature change. The slash or added line indicates replacement of the item is recommended.

The cold-chain indicator 122 in still other examples includes a temperature-sensitive substance, such as a thermometer or thermo-chromatics. When a temperature change outside a predetermined threshold temperature range occurs, a reaction takes place in the temperature-sensitive substance that irreversibly changes an image, such as a watermark, on the indicator to identify the temperature increase. The change is permanent. Even if the temperature of the item subsequently drops back down to into the predetermined threshold temperature range, the change in appearance of the cold-chain indicator 122 remains unaltered.

The cold-chain indicator 122 can be used on any type of perishable or comestible items requiring maintenance within a temperature range to prevent spoilage, such as, but not limited to, ice cream, milk, butter, yogurt, etc.

The cold-chain indicator 122 optionally can include blockchain traceability. In these examples, the indicator activates to print blockchain identifying numbers on the item package in irreversible color changing ink. This ensures the item is genuine (the blockchain) and that it's preserved properly (the ink mark). In some examples, the indicator holds one or more hash addresses. The cold-chain indicator (watermark) can alter appearance upon activation to change a block to a spoiled block and/or auto add a block for the chain.

The cold-chain indicator 122 in yet other examples employs a color changing ink to visually depict a previous temperature of an item or ambient temperature surrounding an item. The temperature data can be captured at (for instance) the point-of-sale (POS) area to determine the temperature of frozen or chilled products and to optimize the placement of these items for cold chain compliance.

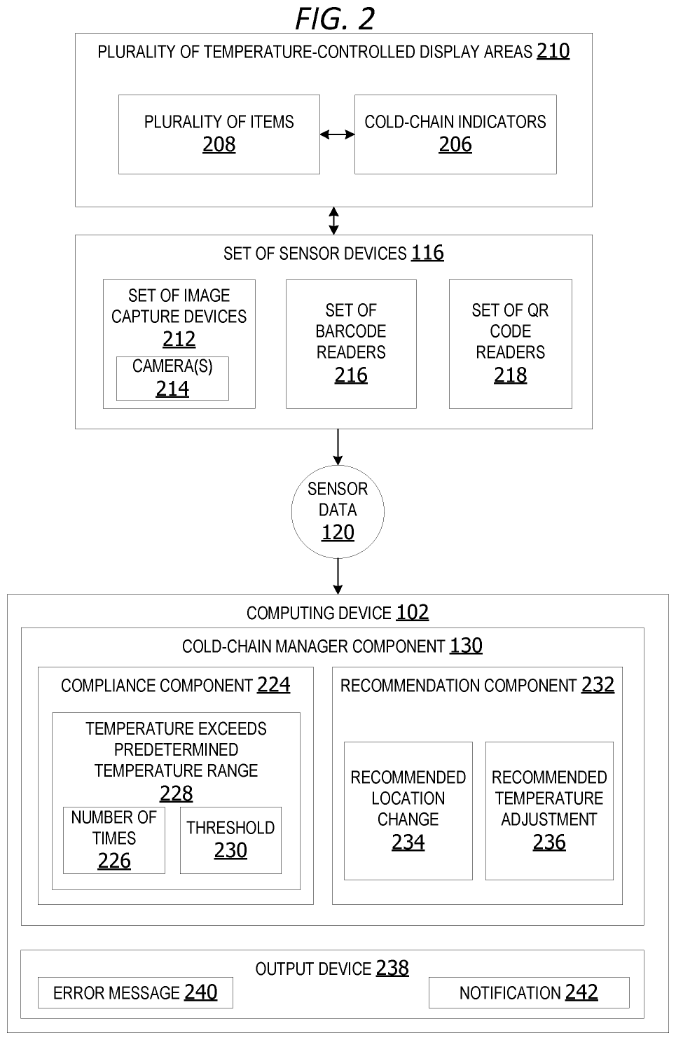

FIG. 2 is an exemplary block diagram illustrating a system 200 for managing temperature-controlled display areas for cold-chain compliance of items. A set of one or more sensor devices 202 generates sensor data 120 associated with one or more cold-chain indicators 206 on one or more items in a plurality of items 208 within a plurality of temperature-controlled display areas 210. A cold-chain indicator in the cold-chain indicators 206 can include, without limitation, an indicator such as the cold-chain indicator 122 in FIG. 1.

A temperature-controlled display area is a display area which is heated or cooled to maintain a predetermined temperature or temperature range. The temperature-controlled display area can include a freezer display case, a refrigerated display case, a warming case, a refrigerated truck, a refrigerated storage room, a walk-in-freezer, or any other temperature-controlled area/display. A display can include a counter, case, bin, shelf, end-cap display, or any other type of display. The temperature-controlled display area can include a thermostat, a condenser, a heating element, etc.

The set of sensor devices 116 can include, without limitation, a set of one or more image capture devices 212. An image capture device can include one or more infrared sensors and/or one or more cameras 214 for capturing images of at least a portion of a cold-chain indicator.

The set of sensor devices 116, in other examples, include a set of one or more barcode readers 216 for reading a barcode. A barcode can include a UPC code, a one-dimensional barcode, a two-dimensional barcode (a matrix barcode) or any other type of barcode. In these examples, a cold-chain indicator includes an image of a barcode or a portion of a barcode.

In still other examples, the set of sensor devices 116 includes a set of one or more quick response (QR) code readers 218. A QR code reader 218 is a device for reading QR codes on an item. In these examples, the cold-chain indicator includes a QR code or a portion of a QR code.

A cold-chain manager component 130 running on a computing device 102 analyzes the sensor data 120 to determine whether items in the plurality of items 208 are cold-chain compliant or non-compliant. In some examples, a compliance component 224 analyzes the sensor data 120 to calculate the number of times 226 instances of a selected item had a temperature exceeding a predetermined temperature or temperature range. The sensor data 120 can be gathered while the item is in a temperature-controlled display case or outside a temperature-controlled area, such as when scanned by a scanning device for checkout/purchase by a customer at a checkpoint location, such as a POS, a self-checkout, an item pickup kiosk, an item pickup locker, a grocery pickup area, a loading/unloading area or an exit point of the item selection area.

If the number of times 226 instances of an item stored in the same area exceeds a threshold 230 number, a recommendation component 232 generates a recommended location change 234 for storing the instances of the selected item. In other words, the system can determine that storing/displaying the items in a temperature-controlled display area located closer to the checkpoint or farther away from a heat-source can reduce indicator activation/improve temperature management of the items. The cold-chain manager component 130 analyzes temperature data with a planogram or other data associated with the item selection area to determine if changing the location of the display containing the instances of the selected item improve cold-chain compliance and/or reduce the number of times 226 instances of the item registers a temperature that is too high or too low.

In other examples, the recommendation component generates a recommended temperature adjustment 236 for the temperature-controlled display area assigned to store/display instances of the selected item. The temperature adjustment can be a recommended higher temperature to increase the temperature of the display area. The temperature can be increased to reduce cooling costs. The temperature adjustment in other examples is a recommended lower temperature to decrease the temperature of the at least one temperature-controlled display area. The temperature can be lowered to improve cold-chain compliance and/or improve the quality of items stored in the temperature-controlled display.

The recommended temperature adjustment can be output to a user or user device associated with a user. The recommended temperature adjustment in some examples instructs the user to manually perform the temperature adjustment by changing a thermostat setting or other controls on a cooling device, such as, but not limited to, a condenser on a refrigerated display case or freezer display case. In other examples, the system autonomously performs the temperature adjustment by changing one or more settings on a smart thermostat/temperature controls on the refrigerator/freezer display case or other temperature-controlled area.

An output device 238 is a device for displaying or transmitting data to a user or a user device associated with a user. The output device 238 can include a user interface device, a communications interface device, a display screen, a touch screen, a projector, a speaker, a printer, or any other type of output device.

The output device 238 in some examples outputs an error message 240 to a user and/or a user device associated with the user in response to sensor data 120 indicating the temperature of an item is outside a threshold range or was outside the threshold range at some prior time. The error message 240 indicates the item is non-compliant with cold-chain quality control rules and/or the item should be replaced.

In other examples, the output device 238 outputs a notification 242 to the user and/or the user device. The notification can include the recommended location change 234 and/or the recommended temperature adjustment 236 for the freezer/refrigerated display case(s).

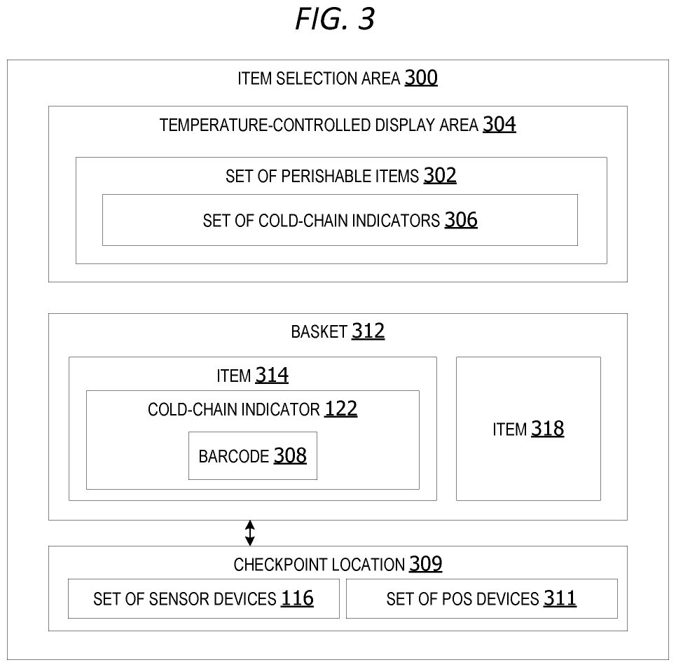

FIG. 3 is an exemplary block diagram illustrating an item selection area 300. The item selection area 300 is an area including a set of one or more perishable items 302 in a temperature-controlled display area 304. The item selection area can be a warehouse, distribution center, a store, a department within a store, or an area/department within a store.

The set of perishable items 302 includes a set of one or more cold-chain indicators 306 removably attached to each item or incorporated into packaging of each item. An indicator in the set of cold-chain indicators can include an indicator, such as, but not limited to, the cold-chain indicator 122 or the cold-chain indicators 206 in FIG. 2.

In some examples, a cold-chain indicator is removably attached to each item in the set of perishable items 302 in this example. A cold-chain indicator can be implemented as, for example, but without limitation, a label on an item, a barcode 308, a QR code, or any other type of indicator. A set of sensor devices 116 reads the cold-chain indicator(s) on one or more items in a basket 312 of items at a checkpoint location 309 within the item selection area 300.

The basket 312 is a set of one or more items grouped together. A basket can include a grocery cart, a physical basket, a motorized cart, a bag, a box, a case or pallet. The basket 312 in some non-limiting examples is a shopping cart on wheels, a hand-held basket, a re-usable shopping bag or any other container for moving items from one location to another within the item selection area 300. The basket 312, in other examples, refers to the set of items selected for purchase by a user/customer regardless of whether the user carries/transports the items in a physical container to the checkpoint location 309.

In some non-limiting example, the basket 312 is an electronic basket of items. An electronic basket is a set of items selected via a website or application enabling a user to create an online grocery order for later pickup or delivery.

In another example, the basket 312 refers to one or more items in a set of items transported by the same user to the checkpoint location. In other words, the basket 312 can refer to the set of items selected by the customer for purchase. The basket of items includes the items carried by a customer in the customer's hands or arms without aid of a bag, basket or physical cart.

The basket 312 of items includes at least one cold-chain indicator 122 attached to at least one temperature-sensitive item 314. The temperature-sensitive item 314 in this example is a comestible or perishable item maintained within a predetermined threshold range to prevent spoilage. The cold-chain indicator 122 in some examples is incorporated into the packaging of the item during manufacture or an add-on placed on the item after manufacture. including a cold-chain indicator 122.

The basket 312 in other examples can include one or more items which are not associated with a cold-chain indicator, such as item 318. Item 318 is an item which does not require maintenance within a temperature-controlled area and/or the item 318 is maintained at ambient/room temperature of the item selection area 300.

The cold-chain indicator 122 in this non-limiting example is a barcode or a portion of a barcode 308. A barcode reader in the set of sensor devices 116 scans the barcode 308 to determine whether the cold-chain indicator 122 is activated. When the cold-chain indicator 122 is not activated (un-activated) the barcode reader reads the barcode 308 to obtain scan data identifying the item and/or price of the item. When activated, the barcode 308 is altered to render the barcode unreadable or altered to generate an error message indicating the item 314 is noncompliant with cold-chain compliance rules/standards.

Cold-chain indicators are scanned/checked at one or more checkpoint locations by a sensor device, such as a barcode reader. A checkpoint location 309 is any location at which a cold-chain indicator on one or more items is checked for cold-chain compliance and/or to gather/collect temperature data from cold-chain indicator(s). A checkpoint location 309 in some examples is located at a checkout area, staging area, pallet-build area or exit point. The checkpoint location 309 in these examples includes a set of one or more POS devices 311.

A POS device in the set of POS devices 311 can include a self-checkout as well as a cashier operated checkout. In another example, the checkpoint location 309 includes a customer service desk, an item pickup area, an item return area, a pallet-build area, a staging area for loading pallets onto a truck, or any other location.

The checkpoint location 309 can be a location within a warehouse, DC, store or other item selection area in which one or more sensor devices gather sensor data, including temperature data, from a cold-chain indicator on an item. The checkpoint location 309 can include an unloading area where items are removed from truck, a loading area where items/pallets are loaded onto trucks, a storage area/backroom area where items are stored prior to stocking shelves, a staging area in a warehouse where items are packed into pallets, a sales floor area where items are stocked/placed into temperature-controlled display cases, or any other area where temperature data is obtained from cold-chain indicators.

A set of one or more sensor devices 310 can be located at the checkpoint location 309 within the item selection area. The set of sensor devices 116 can include one or more cameras, one or more QR code readers, one or more barcode readers or any other type of sensor device. The set of sensor devices 116 can also include robotic sensor devices which autonomously scan item indicators to obtain temperature data as items move down a conveyor belt within a warehouse, at a POS location, or other location within the item selection area. The set of sensor devices 116 reads the cold-chain indicator or captures an image of the cold-chain indicator on each perishable item in a set of items in a user's basket 312 of items.

Cold-chain indicators can be scanned automatically by one or more sensor devices in some examples. A user in other examples manually scans cold-chain indicators using a scanner device, such as, but not limited to, a hand-held scanning device or a mounted scanning device, to obtain the temperature data from a cold-chain indicator. A user can manually scan cold-chain indicators at checkpoint locations such as, but not limited to, an item display during stocking or re-stocking, in a backroom area, during loading or unloading items from a truck into a backroom storage area, at a POS, etc. Item unloaded from a truck can be individual items, items packed into boxes and/or items packed into pallets.

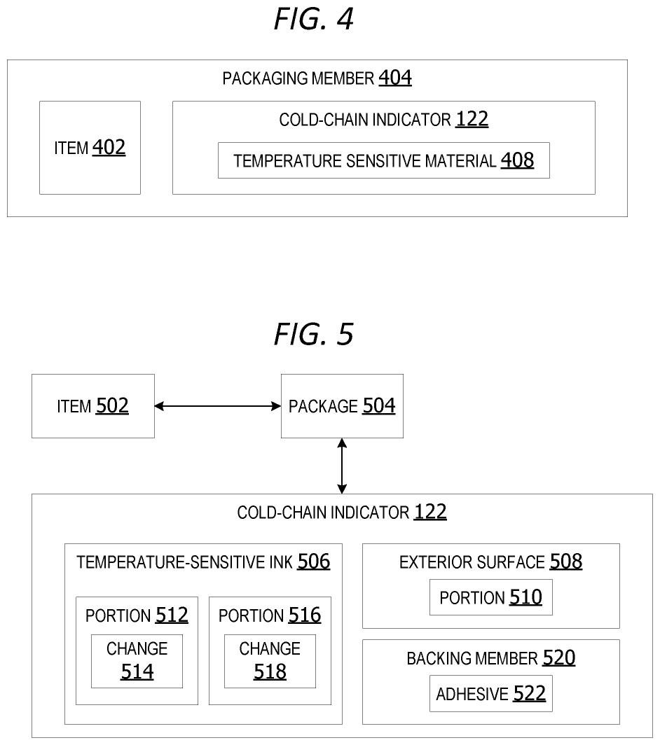

FIG. 4 is an exemplary block diagram illustrating a cold-chain indicator 122 embedded or otherwise integrated within an item package. The cold-chain indicator 122 is part of or embedded within a packaging member 404 surrounding or at least partially enclosing an item 402. The cold-chain indicator 122 is composed of a temperature-sensitive material 408 which changes composition or alters appearance upon occurrence of a predetermined temperature or temperature range.

In some non-limiting examples, the temperature-sensitive material is a temperature-sensitive ink. Temperature-sensitive ink irreversibly changes color or color value (appear or disappear) if the temperature of the ink or item the indicator is goes above a threshold high temperature or below a threshold low temperature. The temperature threshold can vary depending on the type of temperature-sensitive ink utilized.

In some examples, the temperature-sensitive ink activates to change the color or appearance of the ink (hue or color value) based on a temperature selected from a scale of ten degrees Celsius to sixty-five degrees Celsius. In other examples, the temperature-sensitive ink activates at temperatures below ten degrees Celsius or above sixty-five degrees Celsius.

The cold-chain indicator in other examples includes a temperature strip or stick-on thermometer which permanently records temperature changes on the indicator. In other words, the stick-on cold-chain indicator includes temperature-sensitive ink such that when a temperature is registered, the indicator irreversibly activates to identify that temperature permanently on the indicator. Thus, if the indicator registers a temperature of twenty degrees Fahrenheit and twenty-five degrees Fahrenheit, the cold-chain indicator “thermometer” image shows activation of the temperature markings for both twenty degrees and twenty-five degrees simultaneously and permanently on the indicator. Thus, providing an accurate record of all temperature readings and temperature fluctuations associated with the item to which the indicator is attached.

FIG. 5 is an exemplary block diagram illustrating a cold-chain indicator 122 attached to an item 502 and/or a portion of an item package 504. The cold-chain indicator 122, in some examples, includes temperature-sensitive ink 506 on an exterior surface 508 of the cold-chain indicator or a portion 510 of the exterior surface 508.

A color of the temperature-sensitive ink 506 is configured to change hue, value and/or intensity (saturation) in response to an occurrence of a predetermined temperature and/or a temperature range. In some examples, a portion 512 of the temperature-sensitive ink 506 is adapted to change 514 in response to a first temperature and a second portion 516 of the temperature-sensitive ink 506 is adapted to change 518 in response to a different second temperature.

For example, if the temperature of the item reaches thirty-eight degrees the first portion of the ink can change color, hue, value and/or intensity to make a “38” visible on the indicator. If the temperature of the item 502 then reaches a temperature of forty degrees, the second portion 516 of the temperature-sensitive ink 506 activates to change the color, hue, value and/or intensity of the ink in a second mark change to make a “40” ink mark visible on the indicator. Thus, the indicator accurately records/displays all temperatures to which the item is exposed. For example, but without limitation, a user can visually examine an indicator to determine that at some prior time the item 502 reached a temperature of thirty-eight degrees and a temperature of forty degrees, even if the item's current temperature is thirty-nine degrees.

The cold-chain indicator 122 in this example includes an adhesive 522 backing member 520. The adhesive 522 enables the cold-chain indicator 122 to be removably attached to the item 502 or the package 504 like a sticker. A cold-chain indicator 122 in other examples is added to an item or item packaging during manufacture, at a warehouse, at a distribution center, during shipping, when received at a store, or when stocked in a temperature-controlled display case or other temperature-controlled display area.

In other examples, the cold-chain indicator is permanently incorporated into the item package 504. The cold-chain indicator can be embedded within the item package 504 during manufacture of the item and/or the item package 504.

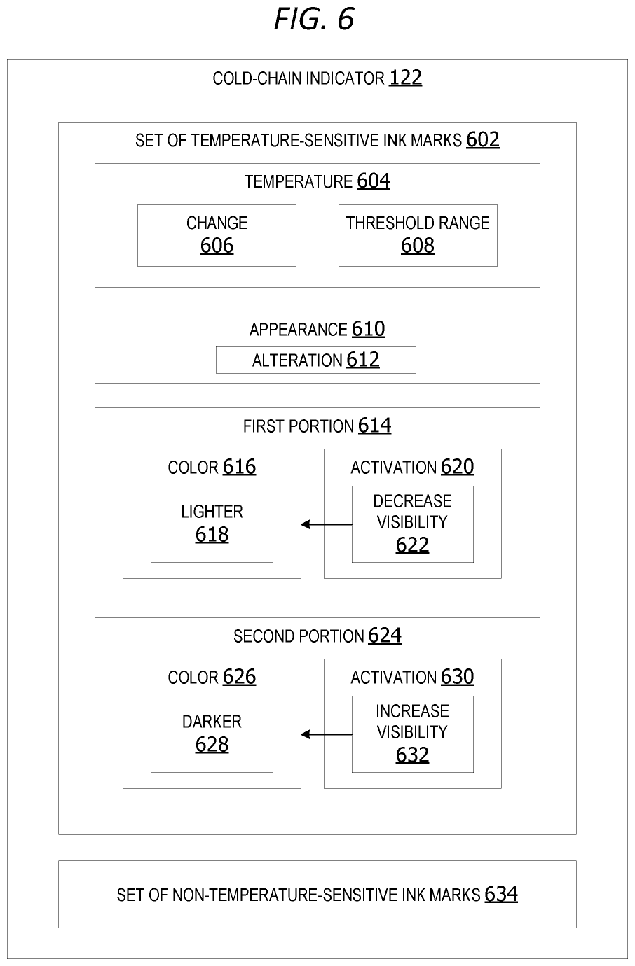

FIG. 6 is an exemplary block diagram illustrating a cold-chain indicator 122 including a set of temperature-sensitive ink marks 602. A temperature 604 change 606 above a predetermined temperature or outside a predetermined temperature threshold range 608 triggers the set of temperature-sensitive ink marks 602 to activate. Activation results in an irreversible alteration 612 to an appearance 610 of the set of temperature-sensitive ink marks 602 providing a visible indication of previous temperature changes. In other words, once the cold-chain indicator 122 is activated and an appearance of the cold-chain indicator alters to indicate occurrence/detection of a temperature outside a threshold temperature range, the change/appearance alteration is a permanent and irreversible alteration.

In some examples, a color 616 of a first portion 614 of the cold-chain indicator 122 fades or becomes lighter 618 in response to activation 620 of the cold-chain indicator at a first temperature to decrease visibility 622 of the temperature-sensitive ink marks and/or make the marks more difficult to read. When the ink fades, in some non-limiting examples, it alters the appearance of a label, barcode or QR code to generate an error message indicating the item is non-compliant with cold-chain guidelines. For example, if a portion of a barcode fades, scanning the barcode can generate a “replace item” message rather than outputting the identification and/or price of the item.

In another example, the temperature-sensitive ink marks when visible indicate cold-chain compliance of the item. When all or a portion of the temperature-sensitive ink marks fade, the temperature-sensitive ink marks become invisible to the human eye and/or invisible to scanning devices or other sensor devices. If the temperature-sensitive ink marks are invisible, the lack of the temperature-sensitive ink marks indicate the item does not comply with cold-chain compliance/temperature of the item fell outside an acceptable temperature range at some time.

In other examples, a color 626 of a second portion 624 of the temperature-sensitive ink marks become darker 628 in response to activation 630 of the cold-chain indicator 122 at a second temperature to increase visibility 632 of a portion of a label, barcode, QR code or other ink marks on the item.

In still other examples, both the first portion and the second portion of the temperature-sensitive ink marks fade in response to exposure of the indicator to the predetermined temperature(s). In yet other examples, both the first portion and the second portion of the temperature-sensitive ink marks become more prominent/visible (darker) in response to exposure of the indicator to the predetermined temperature(s).

The temperature-sensitive ink marks in still other examples are completely invisible when the cold-chain indicator is un-activated. The temperature-sensitive ink marks become partially or completely visible upon activation of the cold-chain indicator. The cold-chain indicator activates if the temperature registered by the cold-chain indicator is higher than a maximum temperature or lower than a minimum temperature.

The cold-chain indicator 122 activation makes a warning label, which was previously invisible to the human eye, visible/legible, in some examples. The activation can result in a temperature reading becoming irreversibly visible/readable in another example. The warning label can include text such as, but not limited to, “replace item,” “non-compliant item,” “too warm,” or any other text. Other text/warning labels can read “temperature threshold reached” or “temperature compliant.” In still other examples, the color 626 of the indicator alters/changes color to indicate a change in temperature. In one non-limiting example, the color 626 changes from a white or clear color to a yellow, red, orange or any other color indicating the item is non-compliant or not suitable for the item's intended use.

The cold-chain indicator 122 in another example includes a continuous color spectrum in which each color displayed on the indicator corresponds to a temperature or temperature range registered by the indicator. In other words, each color or color band on an indicator can represent a different temperature a given item was exposed to for a threshold time-period.

In some non-limiting examples, a first color indicates exposure to temperatures within a recommended range, a second, different color mark indicates exposure to a temperature outside the recommended range but within an acceptable temperature range and a third different color mark indicates exposure to temperatures within an unacceptable temperature range. For example, a green color band on the indicator can indicate exposure to temperatures within a recommended range and a yellow color band next to the green can indicate occurrence/detection of a temperature slightly above the recommended temperature but still within the acceptable temperature range. A red color on the indicator in can indicate the item became too warm during transport and the item should be replaced. Likewise, a blue color can optionally indicate an item temperature fell below the recommended temperature range (too cold) for that item.

A camera can capture an image of the one or more colors on an indicator attached to or associated with a selected item. An analysis component analyzes the image data to generate temperature data, including the temperatures of the items at various time-periods, based on the color(s) and/or color ranges on the indicator. The system analyzes the time and/or temperature data using assigned locations of items and the calculated warming rate to predict possible routes of the selected item through a warehouse, DC or other item selection area.

In some examples, when the cold-chain indicator 122 activates, the cold-chain indicator 122 is altered to add lines to a barcode and/or remove lines from a barcode to change data read by a barcode reader device when the cold-chain indicator 122 is scanned. In other examples, when the cold-chain indicator 122 activates, the cold-chain indicator 122 is altered to add a slash through a label, icon, image, text, barcode or QR code on an item or packaging. The slash prompts output of an error message by the barcode scanner device. The activation can optionally also result in a temperature reading becoming irreversibly visible on the indicator.

The cold-chain indicator 122 can optionally include a set of non-temperature sensitive ink marks 634 which do not change or alter appearance based on temperature fluctuations. For example, a portion of a barcode can be composed of non-temperature sensitive ink ensuring at least a portion of the barcode remains readable to prevent a cashier from manually entering the barcode at a POS device.

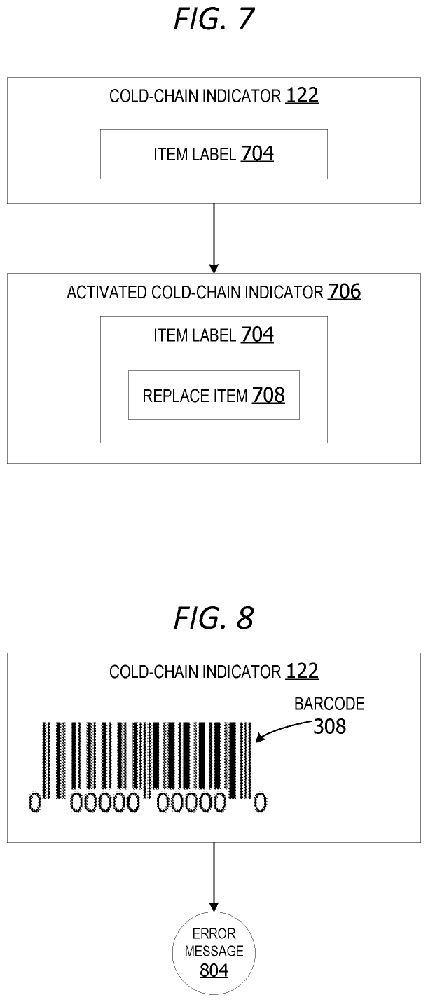

FIG. 7 is an exemplary block diagram illustrating activation of a cold-chain indicator 122. In this example, the cold-chain indicator 122 is an item label 704 or a portion of an item label 704. If the cold-chain indicator 122 registers a temperature outside an acceptable temperature threshold range, the cold-chain indicator 122 activates. When activated, the cold-chain indicator 706 alters all or a portion of the item label 704.

In this non-limiting example, text on the item label 704 becomes visible or darkens to improve legibility. The text which becomes visible in this example says “replace item” 708. In other examples, the text includes one or more previous temperatures of the items, instructions to return or dispose of the item, a warning not to sell the item, a warning not to consume the item, a warning that the item is or has been too warm and/or text providing a warning that the item is unsuitable for use.

FIG. 8 is an exemplary block diagram illustrating a cold-chain indicator 122 including at least a portion of a barcode 308. The barcode 308 in this example is printed in temperature-sensitive ink which permits the barcode to be read by a barcode scanner or other sensor device. Upon activation, the barcode alters to trigger output of a message. In this non-limiting example, scanning the barcode 308 of the activated cold-chain indicator 122 causes the system to generate an error message 804.

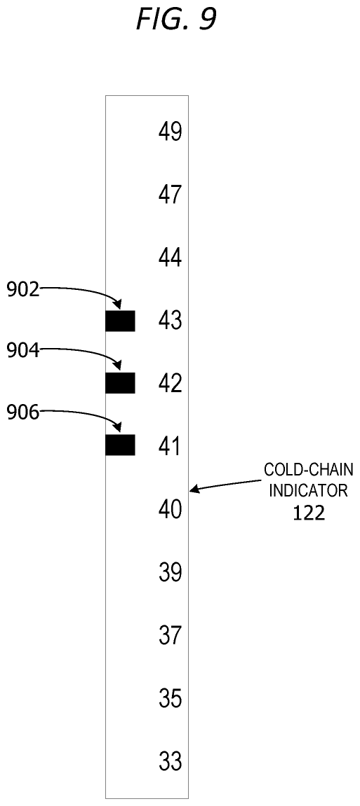

FIG. 9 is an exemplary block diagram illustrating a cold-chain indicator 900 including temperature indicators. In this example, as each temperature or temperature range is detected, the cold-chain indicator 122 alters to irreversibly indicate the detected temperature of the item associated with the cold-chain indicator 122. For example, the activated temperature-sensitive ink marks at 902 indicate the item registered a temperature of forty-three degrees, the marks at 904 indicate the item registered a temperature of forty-two degrees, and the marks at 906 indicate the item registered a temperature of forty-one degrees. The activated cold-chain indicator 900 in this example provides a record of all temperature changes associated with any items attached to the cold-chain indicator 122.

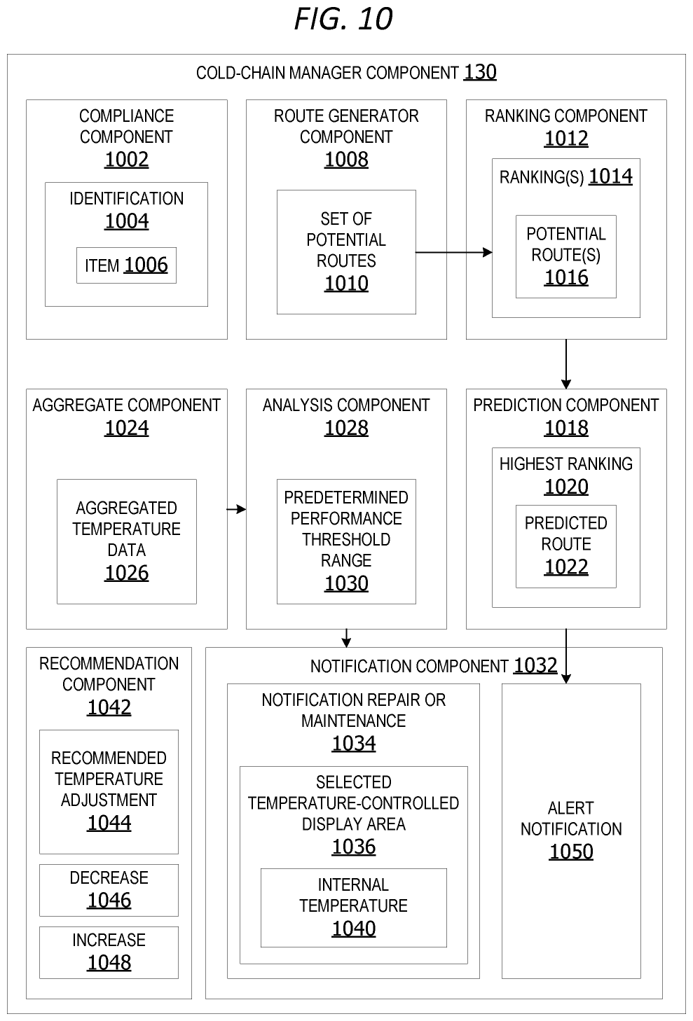

FIG. 10 is an exemplary block diagram illustrating a cold-chain manager component 130. A compliance component 1002 analyzes sensor data associated with a set of one or more perishable items to identify at least one item in the set of perishable items associated with an activated cold-chain indicator. The identification 1004 of the item 1006 verifies occurrence of a change in the temperature associated with the item 1006 fell outside the per-item threshold temperature range for the selected item 1006 at some prior time. A notification component 1032 outputs an alert notification 1050 indicating the item 1006 is non-compliant or should be replaced if the cold-chain indicator associated with the item 1006 has been activated. The notification is displayed directly to the user via a user interface device or sent to a user device associated with the user.

A route generator component 1008 analyzes the sensor data with item data, a current temperature of the item and a predetermined warming rate to generate a set of potential routes through the item selection area traversed by a selected item while outside a temperature-controlled area within the item selection area.

In other words, each potential route in the set of potential routes is a route that one or more items in a basket of items has taken from one or more temperature-controlled area to a checkpoint location within the item selection area or other portion of a retail environment. For example, if a basket of items includes a loaf of bread and a gallon of milk, one potential route involves a path which begins at the bakery, proceeds to the diary section of the store and ends at the checkpoint location. Another potential route begins at the dairy section where the milk is stored to the bakery section and then to the checkpoint location.

In other examples, the route generator component 1008 calculates possible routes through which a selected item has taken through an item selection area/retail environment from a first assigned location within an item selection area to a second location within the item selection area based on the current temperature of one or more items in a basket, temperature of temperature-sensitive (cold-chain) items, temperature of items which are not temperature-sensitive (items which do not require refrigeration/freezing), a planogram or map of the item selection area, assigned display or storage locations within the item selection area of items in the basket, internal temperature of storage locations/temperature-controlled displays, ambient temperature within the item selection area, amount of time since removal of at least one item from the item's assigned temperature-controlled display area, season, weather, date, time and/or warming rate. The warming rate is calculated in accordance with Newton's Law of Cooling.

With some level of accuracy, the system estimates the route of an item or a basket of items through an item selection area, such as a warehouse, DC or store. For example, if there are four possible routes from a first assigned location of the item (temperature-controlled area) in a warehouse to a second location (checkout, pallet build area or exit point) and there is at least one additional item in the basket of items (selected set of items), the set of four potential routes can be narrowed to three or fewer potential routes based on the assigned location of the additional item(s).

The system estimates routing of individual items, baskets of items, cases of items or pallets of items through a DC, warehouse, store or other location by using the time-since-removal of the item from an assigned temperature-controlled area and the corresponding temperatures of each item in the same basket, case or pallet when they were removed and/or when the indicator is checked/scanned. The routing component calculates routes for item(s) in other examples by fixing a single point in time.

A ranking component 1012 analyzes the set of potential routes 1010 using the item data to generate one or more rankings 1014 for each potential route 1016 in the set of potential routes 1010. The ranking component 1012 ranks each potential route in the set of potential routes based on one or more other items in the basket of items if the basket of items includes at least two items. The ranking component 1012 assigns each potential route an equal ranking if the basket of items includes a single item.

If the basket of items comprises two or more items, a prediction component 1018 identifies a highest ranking 1020 potential route 1022 in the set of predicted routes. The highest ranking 1020 potential route 1022 is the predicted route most likely to have been taken by the item(s). If the basket of items contains a single item, all potential routes have equal ranking.

An aggregate component 1024 aggregates temperature data for a plurality of items assigned to a selected temperature-controlled display area. The aggregated temperature data 1026 includes the current temperature of a temperature-controlled display and/or temperature data obtained from one or more cold-chain indicators on items stored within the temperature-controlled display and/or removed from the temperature-controlled display for purchase. The aggregated temperature data 1026 includes aggregated data, such as, the temperature data 136 in FIG. 1.

An analysis component 1028 analyzes the aggregated temperature data 1026 with a predetermined performance threshold range 1030 for the selected temperature-controlled display area.

The analysis component 1028 determines whether the temperature-controlled display is maintaining the proper internal temperature and/or otherwise functioning properly based on the analysis results. If the internal temperature is lower or higher than expected, the system determines maintenance or repair is recommended. If the motor is operating below expected performance parameters, the system determines if maintenance or repair is recommended. Likewise, if a threshold number of items within a selected temperature-controlled display area (refrigerated display case or freezer case) becomes too warm within a threshold time-period, the system determines the selected temperature-controlled display area requires maintenance or repair.

A notification component 1032 outputs a maintenance or repair notification 1034 identifying the selected temperature-controlled display area 1036 for maintenance or repair if the internal temperature 1040 or other performance indicator demonstrates the selected temperature-controlled display area is operating/performing outside the predetermined performance threshold range. The maintenance or repair notification 1034 is a notification indicating that a refrigerated display case or freezer display case not scheduled for maintenance can require unscheduled maintenance or repair. Maintenance can include, without limitation, cleaning condenser coils. Repair can include, without limitation, repairing or replacing broken or malfunctioning parts.

In other examples, a recommendation component 1042 generates a recommended temperature adjustment 1044 for the at least one temperature-controlled display area to decrease 1046 the internal temperature 1040 or increase 1048 the internal temperature 1040 of the at least one temperature-controlled display area. The temperature can be adjusted downward if items stored in the display are registering temperatures that are warmer than desired. The system can recommend increasing the temperature if items in the display are colder than necessary.

The system can optionally adjust the thermostat on one or more temperature-controlled display cases (refrigerated case/freezer case) autonomously to change the internal temperature in an area. The system automatically adjusts the thermostat in response to determining an increase in temperature or decrease in temperature is recommended. In these examples, a recommendation is not sent to a user to manually alter the thermostat. Instead, the system performs the temperature adjustment via a smart thermostat associated with one or more of the temperature-controlled display cases. The smart thermostat can be controlled via a network connection to a server or other computing device associated with the smart thermostat. In these examples, the system optionally sends a notification to a user device notifying the user that the thermostat on a temperature-controlled display case has been automatically adjusted upward (increase internal temperature) or downward (decrease internal temperature).

Thus, the system in some non-limiting examples performs real-time analytics on temperature data gathered from one or more cold-chain indicators associated with one or more items to infer one or more routes the item(s) can have taken from a first temperature-controlled location to a second location within an item selection area based on the temperature or condition of an item. The system heuristically predicts multiple potential routes based on the time the item has spent outside the assigned temperature-controlled display area (time since removal from the display) prior to scanning/inspection of the cold-chain indicator at the second location. The system calculates the percentage of accuracy of the predicted route(s) based on the other items in the same basket (apart from the item in question). The second location can be a POS or other checkout area. The route with the most matches/highest percentage match is confirmed or selected as the most likely predicted route traversed by the selected temperature-sensitive item.

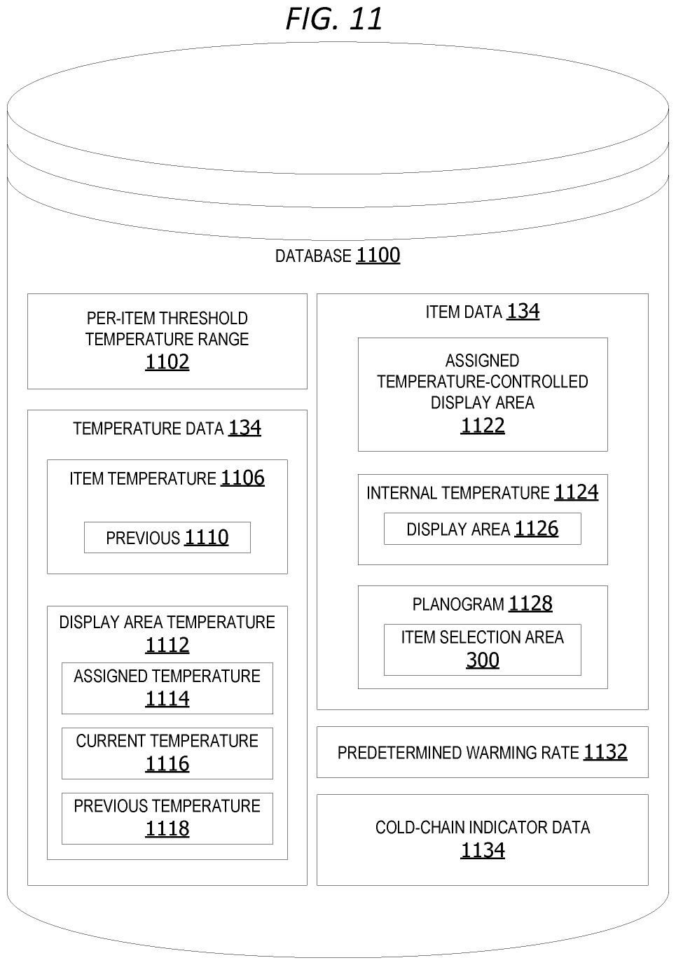

FIG. 11 is an exemplary block diagram illustrating a database 1100 storing cold-chain compliance data. The cold-chain compliance data can include a per-item threshold temperature range 1102. The threshold temperature range is the temperature or temperatures at which the item can be stored/maintained for cold-chain compliance.

In some examples, all perishable items in a set of items have the same threshold temperature range. In other examples, each item or type of item can have a customized (unique) threshold temperature range. A type of item includes a category or classification of items. For example, a type of item can include frozen foods type, a milk/dairy type, etc. Frozen food items can include sub-types such as ice cream, frozen meals, etc. Each type or sub-type, such as frozen foods, can have a threshold temperature range of five to ten degrees Fahrenheit while chilled items, such as milk, can have a higher threshold temperature range of thirty to thirty-five degrees Fahrenheit.

In other examples, the threshold temperature range can include a maximum temperature threshold. For example, the threshold can specify that milk be maintained at a maximum temperature of forty degrees or forty-five degrees Fahrenheit.

Temperature data 136 is data describing the current and/or previous temperatures 1106 for items subject to cold-chain compliance and/or temperature-controlled displays. Temperature data 136 in this example includes a current item temperature 1106 and/or previous 1110 temperatures of an item. Display area temperature 1112 can include the assigned (desired) temperature 1114 for the inside of the display, the current (actual) temperature 1116 inside the display area and/or previous temperatures 1118.

Item data 134 includes assigned temperature-controlled display area 1122 for each item, location of temperature-controlled display areas, internal temperature 1124 of each display area 1126, and/or a planogram 1128 of an item selection area 300. The database 1100 can optionally include a predetermined warming rate 1132 and/or cold-chain indicator data 1134. Cold-chain indicator data 1134 can include temperature data obtained from a given cold-chain indicator.

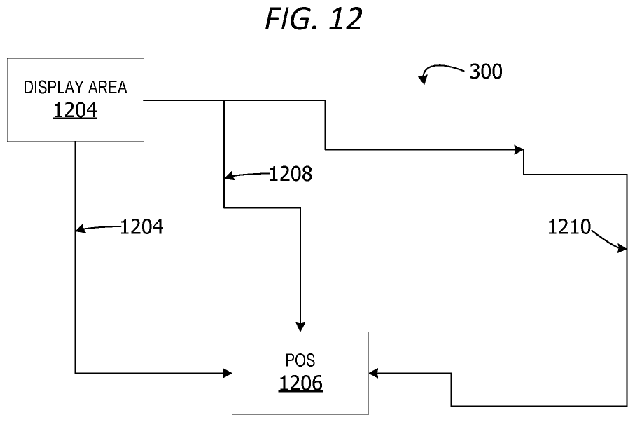

FIG. 12 is an exemplary block diagram illustrating a set of potential routes through an item selection area 300. A first potential route 1204 is a possible path through the item selection area 300 from the display area location of an item to the POS 1206. The first potential route 1202 is the most direct route to the checkpoint location. The first potential route 1202 in this example is predicted to be the route used (highest ranked route) if the item condition based on temperature of the item at checkout is great (cold-chain compliant).

The second potential route 1208 in the set of potential routes is a route which is predicted to have been used if the condition of the item based on item temperature at checkout is acceptable. The temperature is acceptable if there is a slight temperature increase of the item, but the item temperature remains within an acceptable temperature range for cold-chain compliance. The third potential route 1210 is the longest route (least direct) from the display area location 1204 to the POS 1206. The third potential route 1210 is predicted to be the actual route through the item selection area 300 taken by the item if the condition of the item is unacceptable (too high). The item is unacceptable if the temperature of the item at checkout as indicated by the cold-chain indicator is cold-chain non-compliant.

In some examples, the condition of the item is determined as a function of the item's time outside the temperature-controlled display area assigned to store the item, the ambient temperature inside the item selection area, the internal temperature of the display area (freezer or refrigerated display case), time of the year, etc. In other examples, the condition of the item is determined based on the temperature data obtained from any cold-chain indicators on any items in the same basket, temperature of the display area, temperature inside the store, the assigned display location of every item in the same basket and the warming rate.

FIG. 13 is an exemplary flow chart illustrating operation of the computing device to determine whether a cold-chain indicator is activated based on an analysis of sensor data associated with a cold-chain indicator. The process shown in FIG. 13 can be performed by a cold-chain manager component, executing on a computing device, such as the computing device 102 or the user device 118 in FIG. 1.

The process begins by obtaining sensor data from a set of sensor devices associated with a cold-chain indicator at 1302. The cold-chain indicator is an indicator, such as, but not limited to, the cold-chain indicator 122 in FIG. 1. The set of sensor devices is a set of one or more sensors, such as, but not limited to, the set of sensor devices 116 in FIG. 1.

The cold-chain manager component analyzes the sensor data at 1304. The cold-chain manager is a component, such as, but not limited to, the cold-chain manager component 130 in FIG. 1. The cold-chain manager component determines if the cold-chain indicator is activated at 1306. If no, the process terminates thereafter.

If the cold-chain indicator is activated at 1306, the cold-chain manager component generates an alert notification at 1308. The alert notification is output at 1310. The alert notification can be output to a user via a user interface device. In other examples, the alert notification is transmitted to a user device associated with a user via a network, such as the network 112 in FIG. 1. The process terminates thereafter.

While the operations illustrated in FIG. 13 are performed by a computing device, aspects of the disclosure contemplate performance of the operations by other entities. For example, a cloud service can perform one or more of the operations.

FIG. 14 is an exemplary flow chart illustrating operation of the computing device to manage temperature-controlled item display areas based on cold-chain indicator data. The process shown in FIG. 14 can be performed by a cold-chain manager component, executing on a computing device, such as the computing device 102 or the user device 118 in FIG. 1.

The process begins by aggregating temperature data for a plurality of items assigned to a temperature-controlled display at 1402. The temperature data is data such as, but not limited to, the temperature data 136 in FIG. 1.

The cold-chain manager component analyzes the aggregated temperature data at 1404. The cold-chain manager component determines if the internal temperature of the temperature-controlled display is outside a predetermined threshold range based on the analysis results at 1406. If no, the process terminates thereafter.

If the temperature-controlled display temperature is outside the threshold range at 1406 and a temperature adjustment is needed at 1408, the cold-chain manager component outputs a recommended temperature adjustment for the temperature-controlled display at 1410. The process terminates thereafter.

If a temperature adjustment is not needed at 1408, the cold-chain manager component outputs a maintenance/repair notification at 1412. The maintenance/repair notification can be output to a user via a user interface device. In other examples, the maintenance/repair notification is transmitted to a user device associated with a user via a network, such as the network 112 in FIG. 1. The process terminates thereafter.

While the operations illustrated in FIG. 14 are performed by a computing device, aspects of the disclosure contemplate performance of the operations by other entities. For example, a cloud service can perform one or more of the operations.

FIG. 15 is an exemplary flow chart illustrating operation of the computing device to relocate perishable items based on cold-chain indicator data. The process shown in FIG. 15 can be performed by a cold-chain manager component, executing on a computing device, such as the computing device 102 or the user device 118 in FIG. 1.

The process begins by analyzing temperature data for a plurality of items with a set of potential routes at 1502. The cold-chain manager component identifies the number of times an instance of a selected item falls outside a predetermined temperature range at 1504. The cold-chain manager component determines if the number of times instances of the selected item falls outside the predetermined temperature range exceeds a threshold at 1506. If no, the process terminates thereafter.

If the number of items the temperature of an instance of the selected item falls outside the temperature range exceeds the threshold, the cold-chain manager component generates a recommended location change for a temperature-controlled display for the selected item at 1508. The cold-chain manager component outputs the recommendation at 1510. The recommendation can be output to a user via a user interface device. In other examples, the recommendation is transmitted to a user device associated with a user via a network, such as the network 112 in FIG. 1. The process terminates thereafter.

While the operations illustrated in FIG. 15 are performed by a computing device, aspects of the disclosure contemplate performance of the operations by other entities. For example, a cloud service can perform one or more of the operations.

### Additional Examples

In some examples, a system including changing temperature indicators, such as watermarks, placed on cold/frozen items is provided to identify temperatures and/or temperature ranges to which an item has been exposed. This temperature data is utilized to determine whether an item is cold-chain compliant.

In some examples, the watermark is a mark on a sticker or product packaging placed on frozen or chilled products/items to drive retail store analytics where the analytics include paths/routes from temperature-controlled areas to exit points/checkpoints outside the temperature-controlled areas in the stores and/or average time items spend outside temperature-controlled areas prior to purchase.

The system performs the analysis using data obtained from one or more cold-chain indicators (watermarks) on item(s) to calculate the time the item(s) have spent outside the temperature-controlled display(s) prior to arrival to the checkpoint location. The system can also calculate an estimated or average transport time from the temperature-controlled area to a checkpoint location based on the temperature and/or condition of one or more items arriving at the checkpoint location. The checkpoint location can include, without limitation, a POS or exit point.

A set of sensor devices in some examples are attached to a POS or self-checkout to evaluate the indicators and/or gather temperature data for items prior to exiting the item selection area. These sensors can include infrared or visual sensors which evaluate the color changing label (indicator) on an item to determine the item's temperature. The system uses this temperature information to determine how long each item has been outside a temperature-controlled area (refrigerated case/freezer case).

The system performs the real time analytics to heuristically predict/infer multiple possible routes through a warehouse, DC or store. A route is a path between the item(s) assigned temperature-controlled storage/display areas and a checkpoint location, such as a POS, pallet-build area or other location at which item temperature is checked. A potential route can be a route taken by multiple items carried by a single user, as well as a potential route taken by a single type of item or multiple instances of the same item carried by multiple different users moving through the item selection area. The system evaluates the path(s) taken by cold-chain items using the assortment of items in each basket at checkout and the temperatures of the cold-chain items. The system stores the temperature data including: location, time, temperature, item identifier, etc.

In other examples, the system calculates the percentage of accuracy of the potential route(s) based on the other items in the same basket. The system selects a most likely to have been taken/highest ranked potential route based on the percentage of accuracy/rankings of the potential routes. The system can confirm the highest ranked potential route based on the route with the most matches with respect to the other items in the same basket. Further, if the item in question is the only item in the basket, then all the possible routes from the item's assigned display location to the checkpoint location are given equal ranking. In still other examples, the system predicts the number of instances of an item which is likely to be returned, rejected or flagged based on temperature data obtained from cold-chain indicators.

The outcome is recorded for a multitude of items/transactions in other examples. The outcome can include the final-outcome/user reaction inferred by return of an item, failure to return the item or any other recordable behaviour in the future. If an item is returned, in another non-limiting example, the system performs post-analytics on temperature data aggregated from one or more cold-chain compliant indicators to determine whether temperature adjustments, refrigeration system maintenance/repair, or relocation of temperature-controlled areas is implemented to improve item quality, reduce returns and/or increase overall customer satisfaction.

The temperature data as well as analytics results associated with items having un-activated indicators (cold-chain compliant) as well as items having activated indicators, relationship with other temperature-sensitive items, temperature-controlled display area locations for each item, predicted routes of cold-chain items outside temperature-controlled areas and/or final-outcome is recorded in a data storage for a multitude of cold-chain items. A final-outcome refers to final disposition of an item. The final-outcome can include item purchase, return, replacement, disposal, etc. The final-outcome can optionally include a reason or reason code indicating the reason for the final-outcome. The reason can indicate whether an item was disposed of due to an activated indicator, reaching or nearing an item expiration date, or other reason.

The system uses the relationship between the item in question and the predicted route to generate recommended optimizations to improve item quality and reduce energy usage. For example, the system correlates return rates of the cold-chain items with those for other item selection areas (stores/warehouses/DCs). If a trend is identified, the refrigerators/freezers located in the outlying areas (farthest from exit points/POS) can need to have their temperature adjusted or be relocated nearer the exit points/POS. Likewise, if cold-chain items in a given refrigerated/freezer case are consistently scanned at too warm a state, the case can need cleaning, repair or its setpoint lowered. In other words, if stuff from the same cooler is scanned too warm prior to leaving a warehouse or store, the system adjusts the temperature of that cooler. Likewise, if items from a given case are consistently scanned at a temperature well below the threshold, then the case temperature can be increased, thereby decreasing energy usage and prolonging the life of the refrigeration system.

The system utilizes the analytics to generate recommendations for adjusting/changing temperature of a temperature-controlled display (cooler or freezer) at various times of the day and in various climatic conditions. In other words, the temperature data analysis is utilized to automatically generate recommendations for changing internal temperature/thermostat in the respective freezer/refrigeration units at various times of the day and in various climatic conditions. The recommended temperature adjustment can be a temporary/updated temperature adjustment or a recommended permanent thermostat setting for all temperature-controlled display areas/cases.

These recommendations can also include relocations of freezer/refrigeration units for improved placement/storage of items in DCs, warehouses, storage areas, etc. The system adjusts temperature and display location to optimize power usage and improve energy efficiency by reducing travel distance and/or travel time between temperature-controlled display/storage areas and checkpoint/exit locations. In other words, the system predicts the optimal location for frozen and cold items based on multiple predicted routes. The recommendations are customized for each store (per-store recommendation) based on the unique layout of each store, regional/local trends and per-store sales data to reduce time perishable items spend outside temperature-controlled areas (coolers/freezers) during selection of items by customers.

Alternatively, or in addition to the other examples described herein, examples include any combination of the following:
an adhesive backing member, wherein the cold-chain indicator is removably attached to an exterior package enclosing the at least one item or an exterior portion of the at least one item;
a packaging member at least partially enclosing the at least one item, wherein the cold-chain indicator is incorporated into at least a portion of the packaging member;
a ranking component, implemented on the at least one processor, analyzes the set of potential routes using the item data to generate a ranking for each potential route in the set of potential routes, wherein the ranking component ranks each potential route in the set of potential routes based on one or more other items in a basket of items including the at least one item if the basket of items includes at least two items, and wherein the ranking component assigns each potential route an equal ranking if the basket of items includes a single item;
a prediction component, implemented on the at least one process, identifies a highest ranking potential route in the set of potential routes on condition the basket of items comprises two or more items;
an aggregate component, implemented on the at least one processor, aggregating temperature data for a plurality of items assigned to a selected temperature-controlled display area;
an analysis component, implemented on the at least one processor, analyzing the aggregated data with a predetermined performance threshold range for the selected temperature-controlled display area;
a notification component, implemented on the at least one processor, outputs a notification identifying the selected temperature-controlled display area for maintenance or repair on condition performance of the selected temperature-controlled display area is outside the predetermined performance threshold range;
an aggregate component, implemented on the at least one processor, aggregating temperature data for a plurality of items assigned to a plurality of temperature-controlled display area;
an analysis component, implemented on the at least one processor, analyzing the aggregated data with the item data to identify at least one temperature-controlled display area having an internal temperature outside a predetermined temperature-range;
a recommendation component, implemented on the at least one processor, generates a recommended temperature adjustment for the at least one temperature-controlled display area to decrease the internal temperature or increase the internal temperature of the at least one temperature-controlled display area;
an analysis component, implemented on the at least one processor, analyzes temperature data for a plurality of items assigned to a plurality of temperature-controlled display areas with a set of potential routes associated with the plurality of items;
a cold-chain compliance manager component, implemented on the at least one processor, identifies the number of times a temperature of an instance of the selected item exceeds a predetermined temperature-range;
a recommendation component, implemented on the at least one processor, generates a recommended location change for a temperature-controlled display area assigned to the selected item on condition the number of times the temperature of instances of the at least one item exceeds the predetermined temperature-range exceeds a threshold;
a set of barcode readers generating barcode data associated with the set of perishable items, wherein the activated cold-chain indicator comprises at least a portion of a barcode on a selected item, wherein the activated cold-chain indicator changes an appearance of the barcode to trigger output of an error message;
an output device displays the error message on condition at least one barcode reader scans the activated cold-chain indicator associated with the at least one item, wherein the temperature-sensitive ink associated with a portion of a barcode on the at least one item fades or becomes visible in response to the change in temperature of the at least one item;
generating, by a route generator component, a set of potential routes through the item selection area taken by a user to gather a set of items including the selected item based on temperature of one or more items in the set of items, assigned location of one or more items in the set of items within the item selection area, an internal temperature of a temperature-controlled display area assigned to the selected item, ambient temperature of the item selection area, and a warming rate;
ranking, by a ranking component, each route in the set of potential routes based on an identification of each item in the set of items including the selected item and a planogram identifying an assigned location of each item in the set of items on condition the set of items comprises at least two items;
assigning, by the ranking component, an equal ranking to each route in the set of potential routes on condition the set of items includes a single item;
selecting, by a prediction component, a highest ranking potential route in the set of potential routes on condition the set of items comprises two or more items;
analyzing, by an analysis component, temperature data for a plurality of items assigned to a plurality of temperature-controlled display areas with item data associated with the set of items;
identifying at least one temperature-controlled display area having an internal temperature outside a predetermined temperature-range;
generating, by a recommendation component, a recommended temperature adjustment for the at least one temperature-controlled display area to decrease the temperature of the at least one temperature-controlled display area or increase the temperature of the at least one temperature-controlled display area;
analyzing, by an analysis component, temperature data for a plurality of items assigned to a plurality of temperature-controlled display areas with a set of potential routes associated with the plurality of items;
identifying the number of times any cold-chain indicator associated with an instance of the selected item detects a temperature change exceeding a predetermined temperature-range;
generating, by a recommendation component, a recommended location change for a temperature-controlled display area assigned to the selected item on condition the number of times the cold-chain indicator detects the temperature change of an instance of the selected item exceeds the predetermined temperature-range exceeds a threshold value;
aggregating, by an aggregate component, temperature data for a plurality of items assigned to a selected temperature-controlled display area;
analyzing, by an analysis component, the aggregated data using a predetermined performance threshold range for the selected temperature-controlled display area;
outputting, by a notification component, a notification identifying the selected temperature-controlled display area for maintenance or repair on condition performance of the selected temperature-controlled display area is outside the predetermined performance threshold range;
an adhesive backing member, wherein the cold-chain indicator is removably attached to a package enclosing the at least one item or an exterior portion of the at least one item;
wherein the cold-chain indicator is incorporated into at least a portion of a packaging member at least partially enclosing a selected item;
wherein the temperature-sensitive ink further comprises at least a portion of a barcode or a quick response code.

At least a portion of the functionality of the various elements in FIG. 1, FIG. 2, FIG. 3, FIG. 4, FIG. 5, FIG. 6, FIG. 7, FIG. 8, FIG. 9, FIG. 10, FIG. 11 and FIG. 12 can be performed by other elements in FIG. 1, FIG. 2, FIG. 3, FIG. 4, FIG. 5, FIG. 6, FIG. 7, FIG. 8, FIG. 9, FIG. 10, FIG. 11 and FIG. 12, or an entity (e.g., processor 106, web service, server, application program, computing device, etc.) not shown in FIG. 1, FIG. 2, FIG. 3, FIG. 4, FIG. 5, FIG. 6, FIG. 7, FIG. 8, FIG. 9, FIG. 10, FIG. 11 and FIG. 12

In some examples, the operations illustrated in FIG. 13, FIG. 14 and FIG. 15 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “cellular” as used herein refers, in some examples, to a wireless communication system using short-range radio stations that, when joined together, enable the transmission of data over a wide geographic area. The term “NFC” as used herein refers, in some examples, to a short-range high frequency wireless communication technology for the exchange of data over short distances.

While no personally identifiable information is tracked by aspects of the disclosure, examples have been described with reference to data monitored and/or collected from the users. In some examples, notice is provided to the users of the collection of the data (e.g., via a dialog box or preference setting) and users are given the opportunity to give or deny consent for the monitoring and/or collection. The consent can take the form of opt-in consent or opt-out consent.

### Exemplary Operating Environment

Exemplary computer-readable media include flash memory drives, digital versatile discs (DVDs), compact discs (CDs), floppy disks, and tape cassettes. By way of example and not limitation, computer-readable media comprise computer storage media and communication media. Computer storage media include volatile and nonvolatile, removable and non-removable media implemented in any method or technology for storage of information such as computer-readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other general purpose or special purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, microprocessor-based systems, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform tasks or implement abstract data types. Aspects of the disclosure can be implemented with any number and organization of such components or modules. For example, aspects of the disclosure are not limited to the specific computer-executable instructions or the specific components or modules illustrated in the figures and described herein. Other examples of the disclosure include different computer-executable instructions or components having more functionality or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for monitoring cold-chain compliance via one or more temperature-sensitive indicators. For example, the elements illustrated in FIG. 1, FIG. 2, FIG. 3, FIG. 4, FIG. 5, FIG. 6, FIG. 7, FIG. 8, FIG. 9, FIG. 10, FIG. 11 and FIG. 12, such as when encoded to perform the operations illustrated in FIG. 13, FIG. 14 and FIG. 15, constitute exemplary means for obtaining sensor data from a set of sensor devices associated with at least one cold-chain indicator on at least one item in a set of items within an item selection area; exemplary means for analyzing the sensor data to determine whether at least one cold-chain indicator is activated; and exemplary means for generating an alert notification if at least one cold-chain indicator is activated to alter an appearance of at least a portion of the exterior surface of the cold-chain indicator in response to detecting a temperature of the selected item outside a per-item threshold temperature range.

In another example, the elements illustrated in FIG. 1, FIG. 2, FIG. 3, FIG. 4, FIG. 5, FIG. 6, FIG. 7, FIG. 8, FIG. 9, FIG. 10, FIG. 11 and FIG. 12, such as when encoded to perform the operations illustrated in FIG. 13, FIG. 14 and FIG. 15, constitute exemplary means for analyzing sensor data to identify at least one item in the set of perishable items associated with an activated cold-chain indicator; exemplary means for verifying occurrence of a change in the temperature associated with the at least one item in the set of perishable items falls outside the per-item threshold temperature range for the selected item; exemplary means for outputting an identification of the at least one item associated with the activated cold-chain indicator; exemplary means for storing item data associated with the set of perishable items; exemplary means for analyzing the sensor data, the item data, a current temperature of the item and a predetermined warming rate; and exemplary means for generating a set of potential routes through the item selection area taken by a user to obtain the set of perishable items from the assigned temperature-controlled display areas associated with the set of perishable items based on a result of the analysis.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing an operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there can be additional elements other than the listed elements. The term “exemplary” is intended to mean “an example of” The phrase “one or more of the following: A, B, and C” means “at least one of A and/or at least one of B and/or at least one of C.”

In an exemplary embodiment, one or more of the exemplary embodiments include one or more localized IoT devices and controllers. As a result, in an exemplary embodiment, the localized IoT devices and controllers can perform most, if not all, of the computational load and associated monitoring and then later asynchronous uploading of summary data can be performed by a designated one of the IoT devices to a remote server. In this manner, the computational effort of the overall system can be reduced significantly. For example, whenever a localized monitoring allows remote transmission, secondary utilization of controllers keeps securing data for other IoT devices and permits periodic asynchronous uploading of the summary data to the remote server. In addition, in an exemplary embodiment, the periodic asynchronous uploading of summary data can include a key kernel index summary of the data as created under nominal conditions. In an exemplary embodiment, the kernel encodes relatively recently acquired intermittent data (“KRI”). As a result, in an exemplary embodiment, KRI includes a continuously utilized near term source of data, but KRI can be discarded depending upon the degree to which such KRI has any value based on local processing and evaluation of such KRI. In an exemplary embodiment, KRI may not even be utilized in any form if it is determined that KRI is transient and can be considered as signal noise. Furthermore, in an exemplary embodiment, the kernel rejects generic data (“KRG”) by filtering incoming raw data using a stochastic filter that provides a predictive model of one or more future states of the system and can thereby filter out data that is not consistent with the modeled future states which can, for example, reflect generic background data. In an exemplary embodiment, KRG incrementally sequences all future undefined cached kernels of data to filter out data that can reflect generic background data. In an exemplary embodiment, KRG incrementally sequences all future undefined cached kernels having encoded asynchronous data to filter out data that can reflect generic background data.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for monitoring cold-chain compliance via temperature-sensitive indicators, the system comprising:
a set of cold-chain indicators associated with a set of perishable items within an item selection area, a cold-chain indicator comprising temperature-sensitive ink associated with at least a portion of an exterior surface of the cold-chain indicator that activates to alter an appearance of the at least the portion of the exterior surface of the cold-chain indicator on condition a temperature of at least one item associated with the cold-chain indicator falls outside a per-item threshold temperature range;
a set of sensor devices generating sensor data associated with the set of cold-chain indicators on each item in the set of perishable items;
a compliance component, implemented on at least one processor coupled to a memory, analyzes the sensor data to identify at least one item in the set of perishable items associated with an activated cold-chain indicator verifying occurrence of a change in the temperature associated with the at least one item in the set of perishable items falls outside the per-item threshold temperature range for the at least one item;
a user interface device outputs an identification of the at least one item in the set of perishable items associated with the activated cold-chain indicator;
a data storage device, communicatively coupled to the at least one processor, storing item data associated with the set of perishable items, the item data comprising an assigned temperature-controlled display area associated with each item in the set of perishable items, an internal temperature of the assigned temperature-controlled display area associated with each item in the set of perishable items, and a planogram associated with the item selection area; and
a route generator component, implemented on the at least one processor, analyzes the sensor data, the item data and a predetermined warming rate to generate a set of potential routes through the item selection area from the assigned temperature-controlled display areas associated with the set of perishable items and a checkpoint location.

2. The system of claim 1, wherein the cold-chain indicator further comprises:
an adhesive backing member, wherein the cold-chain indicator is removably attached to an exterior of a package enclosing the at least one item or an exterior portion of the at least one item.

3. The system of claim 1, further comprising:
a packaging member at least partially enclosing the at least one item, wherein the cold-chain indicator is incorporated into at least a portion of the packaging member.

4. The system of claim 1, further comprising:
a ranking component, implemented on the at least one processor, analyzes the set of potential routes using the item data to generate a ranking for each potential route in the set of potential routes, wherein the ranking component ranks each potential route in the set of potential routes based on one or more other items in a basket of items including the at least one item if the basket of items includes at least two items, and wherein the ranking component assigns each potential route an equal ranking if the basket of items includes a single item.

5. The system of claim 4, further comprising:
a prediction component, implemented on the at least one process, identifies a highest ranking potential route in the set of potential routes on condition the basket of items comprises two or more items.

6. The system of claim 1, further comprising:
an aggregate component, implemented on the at least one processor, aggregating temperature data for a plurality of items assigned to a selected temperature-controlled display area;
an analysis component, implemented on the at least one processor, analyzing aggregated data with a predetermined performance threshold range for the selected temperature-controlled display area; and
a notification component, implemented on the at least one processor, outputs a notification identifying the selected temperature-controlled display area for maintenance or repair on condition performance of the selected temperature-controlled display area is outside the predetermined performance threshold range.

7. The system of claim 1, further comprising:
an aggregate component, implemented on the at least one processor, aggregating temperature data for a plurality of items assigned to a plurality of temperature-controlled display area;
an analysis component, implemented on the at least one processor, analyzing aggregated data with the item data to identify at least one temperature-controlled display area having internal temperature outside a predetermined temperature-range; and
a recommendation component, implemented on the at least one processor, generates a recommended temperature adjustment for the at least one temperature-controlled display area to decrease the internal temperature or increase the internal temperature of the at least one temperature-controlled display area.

8. The system of claim 1, further comprising:
an analysis component, implemented on the at least one processor, analyzes temperature data for a plurality of items assigned to a plurality of temperature-controlled display areas for the set of potential routes associated with the plurality of items;
a cold-chain compliance manager component, implemented on the at least one processor, identifies a number of times a temperature of an instance of a selected item exceeds a predetermined temperature-range; and
a recommendation component, implemented on the at least one processor, generates a recommended location change for a temperature-controlled display area assigned to the selected item on condition the number of times the temperature of instances of the at least one item exceeds the predetermined temperature-range exceeds a threshold.

9. The system of claim 1, wherein the set of sensor devices further comprises:
a set of barcode readers generating barcode data associated with the set of perishable items, wherein the activated cold-chain indicator comprises at least a portion of a barcode on a selected item, wherein the activated cold-chain indicator changes an appearance of the barcode to trigger output of an error message; and
an output device displays the error message on condition the set of barcode readers scans the activated cold-chain indicator associated with the at least one item, wherein the temperature-sensitive ink associated with the at least the portion of the barcode on the at least one item fades or becomes visible in response to the change in temperature of the at least one item.

10. A computer-implemented method for monitoring cold-chain compliance via temperature-sensitive indicators, the computer-implemented method comprising:
analyze, by a compliance component, sensor data generated by a set of sensor devices associated with at least one cold-chain indicator on at least one item in a set of items within an item selection area, a cold-chain indicator comprising temperature-sensitive material associated with at least a portion of an exterior surface of the cold-chain indicator; and
generating an alert notification on condition the temperature-sensitive material is activated to alter an appearance of the at least the portion of the exterior surface of the cold-chain indicator, an activated cold-chain indicator indicates detection of a temperature of a selected item outside a per-item threshold temperature range.

11. The computer-implemented method of claim 10, further comprising:
generating, by a route generator component, a set of potential routes through the item selection area taken by a user to gather the set of items including the selected item based on temperature of one or more items in the set of items, assigned location of one or more items in the set of items within the item selection area, an internal temperature of a temperature-controlled display area assigned to the selected item, ambient temperature of the item selection area, and a warming rate.

12. The computer-implemented method of claim 11, further comprising:
ranking, by a ranking component, each route in the set of potential routes based on an identification of each item in the set of items including the selected item and a planogram identifying an assigned location of each item in the set of items on condition the set of items comprises at least two items; and
assigning, by the ranking component, an equal ranking to each route in the set of potential routes on condition the set of items includes a single item.

13. The computer-implemented method of claim 11, further comprising:
selecting, by a prediction component, a highest ranking potential route in the set of potential routes on condition the set of items comprises two or more items.

14. The computer-implemented method of claim 10, further comprising:
analyzing, by an analysis component, temperature data for a plurality of items assigned to a plurality of temperature-controlled display areas with item data associated with the set of items;
identifying at least one temperature-controlled display area having an internal temperature outside a predetermined temperature-range; and
generating, by a recommendation component, a recommended temperature adjustment for the at least one temperature-controlled display area to decrease the temperature of the at least one temperature-controlled display area or increase the temperature of the at least one temperature-controlled display area.

15. The computer-implemented method of claim 10, further comprising:
analyzing, by an analysis component, temperature data for a plurality of items assigned to a plurality of temperature-controlled display areas with a set of potential routes associated with the plurality of items;
identifying a number of times the cold-chain indicator associated with an instance of the selected item detects a temperature change exceeding a predetermined temperature-range; and
generating, by a recommendation component, a recommended location change for a temperature-controlled display area assigned to the selected item on condition the number of times the cold-chain indicator detects the temperature change of the instance of the selected item exceeds the predetermined temperature-range exceeds a threshold value.

16. The computer-implemented method of claim 10, further comprising:
aggregating, by an aggregate component, temperature data for a plurality of items assigned to a selected temperature-controlled display area;
analyzing, by an analysis component, aggregated data using a predetermined performance threshold range for the selected temperature-controlled display area; and
outputting, by a notification component, a notification identifying the selected temperature-controlled display area for maintenance or repair on condition performance of the selected temperature-controlled display area is outside the predetermined performance threshold range.

17. A cold-chain indicator for monitoring cold-chain compliance, the cold-chain indicator comprising:
a set of temperature-sensitive ink marks on at least at least a portion of an exterior surface of the cold-chain indicator, the set of temperature-sensitive ink marks configured to activate on condition a temperature of an item associated with the cold-chain indicator falls outside a per-item threshold temperature range, a color of activated temperature-sensitive ink fades to decrease visibility of the temperature-sensitive ink or the color of the temperature-sensitive ink darkens to increase visibility of the temperature-sensitive ink, the set of temperature-sensitive ink marks further comprising:
a first portion of temperature-sensitive ink configured to activate on condition the temperature falls outside a first temperature range; and
a second portion of the temperature-sensitive ink configured to activate on condition the temperature falls outside a second temperature range.

18. The cold-chain indicator of claim 17, further comprising:
an adhesive backing member, wherein the cold-chain indicator is removably attached to an exterior package enclosing the at least one item or an exterior portion of the at least one item.

19. The cold-chain indicator of claim 17, wherein the cold-chain indicator is incorporated into at least a portion of a packaging member at least partially enclosing a selected item.

20. The cold-chain indicator of claim 17, wherein the temperature-sensitive ink further comprises at least a portion of a barcode or a quick response code.
